(19) United States
(12) Patent Application Publication
(10) Pub. No.: US 2017/0039534 A1
(43) Pub. Date: Feb. 9, 2017

(54) FINANCIAL TRANSACTION SYSTEMS AND METHODS

(71) Applicant: MY LIFE IT (AUST) PTY LTD, Blackburn (AU)

(72) Inventor: Richard Stanley Smythe, Lower Templestowe (AU)

(21) Appl. No.: 15/332,777

(22) Filed: Oct. 24, 2016

Related U.S. Application Data
(63) Continuation of application No. 14/110,433, filed on Jan. 16, 2014, now abandoned.

(30) Foreign Application Priority Data
Apr. 5, 2011 (AU) 2011901257

(51) Int. Cl. G06Q 20/10; G06Q 20/32

(52) U.S. Cl. CPC G06Q 20/10; G06Q 20/3255

(57) ABSTRACT

A computer-implemented method for facilitating the transfer of funds from a sending account to a receiving account, the method including the steps of: receiving first data from a first device, the first data including: first transaction data representing a first portion of information required to transfer the funds; and second device identification data uniquely identifying a second device; transmitting request data to the second device identified by the second device identification data, at least a portion of the request data being derived from the first data; receiving from the second device second transaction data representing a second portion of the information required to transfer the funds; and generating combined transaction data from the first transaction data and second transaction data for subsequent transmission to a transaction processor.

### CROSS REFERENCE

This application is a continuation and claims benefit of U.S. patent application Ser. No. 14/110,433, filed Jan. 16, 2014, which is a 371 application of PCT/AU12/000327 filed Mar. 30, 2012, and claims priority to Foreign Application No. 2011901257 tiled on Apr. 5, 2011, the specification(s) of which/are incorporated herein in their entirety by reference.

### FIELD

The present invention relates to methods and systems for facilitating the transfer of funds, for example, the payment of funds by a purchaser to a merchant in return for the provision of goods and/or services.

### BACKGROUND

There are numerous mechanisms by which one person (for example, a purchaser of goods and/or services) can transfer funds to another person (for example, a merchant who provides goods and/or services). For example, if the purchaser knows the account details of a merchant, the purchaser may directly deposit funds into the merchant's account. If the merchant possesses the appropriate equipment, the purchaser may use Electronic Funds Transfer at Point Of Sale (EFTPOS) equipment to execute the transfer of funds between accounts. Direct deposit of funds requires attendance at a bank branch, or access to banking computer systems (eg via the Internet). EFTPOS transactions require specialist EFTPOS equipment.

Alternatively, the purchaser may use shadow accounts (such as those implemented by Paypal, Inc) to effect the transfer of funds. However, the use of such shadow accounts generally requires electronic access to the shadow account provider (eg via the Internet).

In another alternative, the purchaser may also choose to use a credit card. Credit cards are a flexible payment mechanism. Point of Sale (POS) equipment may be used to capture the credit card and transaction details necessary for funds transfer. Paper-based imprinting systems may also be used to capture this information. Alternatively, relevant card information may be entered into a form in a website for purchases made over the Internet.

Credit card fraud typically involves the misuse of credit card details, by a person other than the credit card holder. It is desirable to reduce the opportunity for credit card fraud.

Where specialist equipment (such as POS equipment) is used to capture credit card details, the possibility of fraud is relatively low, assuming that the equipment has not been the subject of unauthorised tampering. However, such equipment is not always available. For example, it is inconvenient for tradespeople attending a customer's premises to carry mobile POS equipment in order to receive payment from a customer.

Where electronic equipment for capturing credit card information and transaction details is not available, the credit card information is generally supplied to the merchant, together with an implicit authorisation that the merchant can use those details to execute a transaction. This situation is highly vulnerable to fraud perpetrated by the merchant, or by a person who either intercepts the communication between the customer and the merchant, or gains access to the merchant's records containing the credit card details.

More recently, Internet banking and e-commerce have become more widely used as a mechanism for transferring funds. Internet banking, as the name suggests, requires Internet access (availability of which cannot be guaranteed at all points of sale), and e-commerce has some of the drawbacks referred to above, including that such transactions are highly vulnerable to fraud.

It is desired to address or ameliorate one or more of the aforementioned shortcomings o disadvantages of the prior art, or at least provide a useful alternative.

### SUMMARY

The present invention provides a computer-implemented method for facilitating the transfer of funds from a sending account to a receiving account, the method including the steps of:

receiving first data from a first device, the first data including:
first transaction data representing a first portion of information required to transfer the funds; and
second device identification data uniquely identifying a second device;

transmitting request data to the second device identified by the second device identification data, at least a portion of the request data being derived from the first data;

receiving from the second device second transaction data representing a second portion of the information required to transfer the funds; and

generating combined transaction data from the first transaction data and second transaction data for subsequent transmission to a transaction processor.

The present invention also provides a system for facilitating the transfer of funds from a sending account to a receiving account, the system including:

a first message receiving component for receiving a first SMS message from a first device through a Short Message Service Centre, the first SMS message including:
first transaction data representing a first portion of information required to transfer the funds; and
second device identification data uniquely identifying a second device;

a first message processing component for processing the first SMS message to generate a request SMS message;

a request message transmitting component for transmitting the request SMS message through a Short Message Service Centre to the second device identified by the second device identification data;

a second message receiving component for receiving a second SMS message from the second device through a Short Message Service Centre; the second SMS message containing data representing a second portion of the information required to transfer the funds; and

a message combining component for combining information in the first SMS message with information in the second SMS message to generate combined transaction data for transmission to a transaction processor.

### DRAWINGS

Preferred embodiments of the present invention are hereinafter described, by way of example only, with reference to the accompanying drawings, wherein:

FIG. 1 is a flow chart illustrating a method for facilitating the transfer of funds consistent with an embodiment of the present invention.

FIG. 2 is an illustration of a system for facilitating the transfer of funds consistent with an embodiment of the invention.

### DESCRIPTION

Embodiments of the invention are suitable for facilitating the transfer of funds from a sending account (for example, an account controlled by a purchaser of goods and/or services) to a receiving account (for example, an account controlled by a merchant of the goods and/or services). Although an embodiment will be described in the context of mobile telephones using Short Messaging Service (SMS) messages to transfer data, embodiments of the invention may be implemented with a variety of hardware and communication protocols.

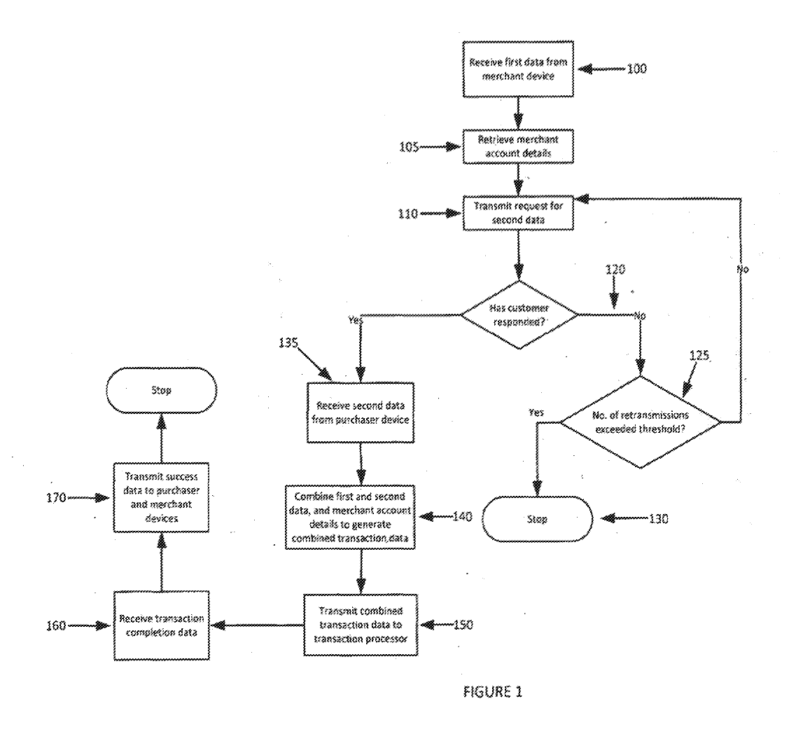

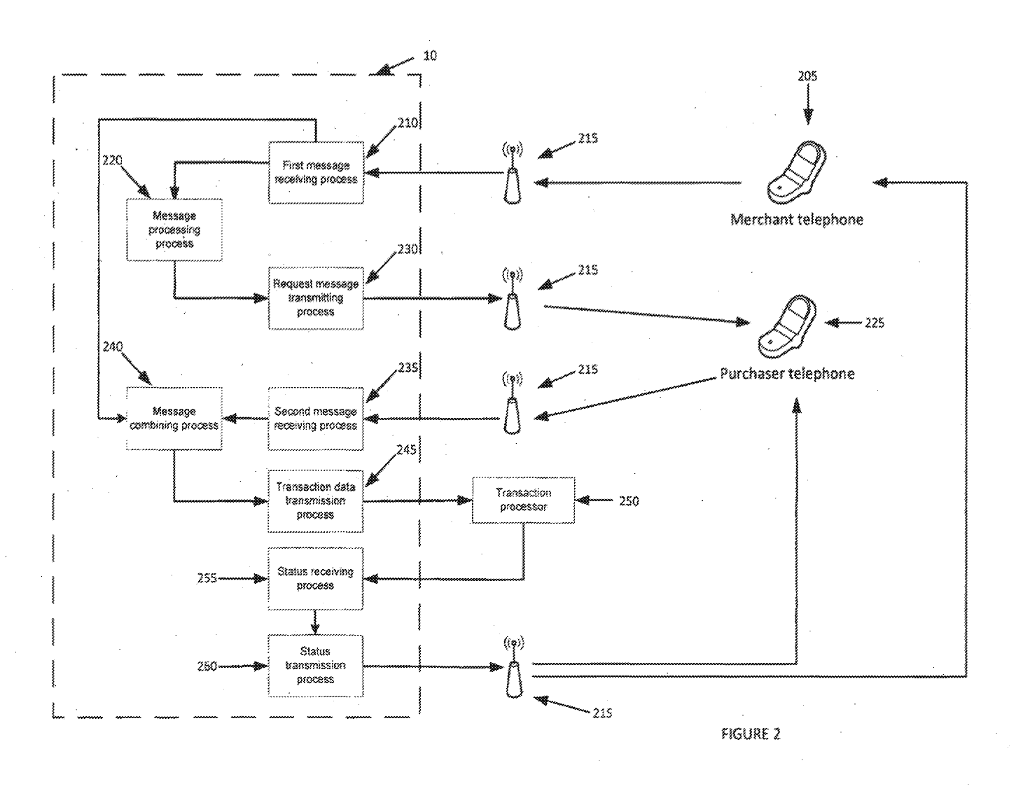

In one embodiment, a computer implemented method for facilitating the transfer of funds is executed by a server 10, referred to hereinafter as an aggregation server. As illustrated in FIG. 1, at step 100, the aggregation server 10 receives first data from a merchant device such as a merchant mobile telephone 205 (illustrated in FIG. 2). The first data sent from the merchant device 205 to the aggregation server 10 includes first transaction data representing a first portion of information required to transfer the funds and second device identification data uniquely identifying a second device. The first data may be in the form of an SMS message, this embodiment being suitable in an exemplary context of a householder paying a service provider, such as a plumber using, a mobile telephone for services rendered. Alternatively, the first data may be generated by software executing on the merchant device, based on data input by the merchant. In this alternative, the merchant device, which could be a portable computing device such as a smartphone or tablet, would execute software which would prompt the merchant for information which would enable the software to generate first data. In a further alternative, the first data may be in the form of data entered into a web-based form by the merchant on a merchant device, the web-based form being generated by the merchant device on instructions from a World Wide Web server, such as the Apache Web Server. For ease of explanation, embodiments of the invention shall be described in the context of the first data being in the form of an SMS message.

The SMS message may contain first transaction data. This first transaction data is, by itself, insufficient to enable the transaction to be executed. This first SMS message is sent from the plumbers mobile telephone and includes partial sending account data representing partial sending account details. The partial sending account data may be a partial credit card number of the householder's credit card. As only part of the householder's credit card number is transmitted in the SMS message from the plumber to the aggregation server 10, if this message is intercepted, the householder's credit card account will remain unidentifiable (a full credit card number being required to identify a credit card account). It is envisaged that the householder will inform the plumber of their partial credit card number, but it is not necessary for the householder to reveal all of the credit card number to the plumber to enter into this first SMS message. This reduces the probability of fraud being committed by the plumber, as the plumber does not have the whole credit card number. Where the first data is not an SMS message, the merchant can enter the partial credit card number using a dedicated software interface, or into a web-based form.

The SMS message from the plumber also includes receiving account identification information identifying the receiving account. The receiving account in this case is the plumber's account into which the funds are to be received. The receiving account identification information may be the mobile telephone number of the plumber, automatically transmitted as part, of the SMS message. Where the first data is not an SMS message, the receiving account information may be stored and sent by software executing on the plumber's device, or may be automatically sent (by means of a persistent cookie or otherwise) as part of a response to a web-based form.

As described above, the SMS message also includes second device identification data uniquely identifying a second device. This may be the purchaser's mobile telephone number, which uniquely identifies the purchaser's mobile telephone (consisting of the handset hardware and Subscriber Identification Module). Although the second device is preferably a mobile telephone, it could be any device in the possession of, or associated with, the purchaser, that is able to be contacted by the aggregation server 10, including a Public Switched Telephone Network (PSTN) line (or land line).

In one embodiment, the merchant has an account registered with the aggregation server 10, such that the aggregation server 10 has an account database (not shown) storing details of the merchant account. The mobile telephone number of the merchant (or any other identifier, such as a cookie, sent with the first data) can be used to retrieve, from this account database, account data representing information about the receiving account (step 105).

The merchant account may be associated with more than one mobile telephone number or other identifier, such that multiple merchant devices can use the same merchant account. This may be useful where there are multiple sales staff in a single organisation. Each staff member can use a device having a unique identifier. An administrator can modify access permissions to the merchant account (through aggregation server 10) so as to authorise or de-authorise devices from using the merchant account, in embodiments of the present invention.

In an alternative embodiment, the merchant is not registered with the aggregation server 10. In this embodiment, the first transaction data (included in the SMS or other message from the plumber) may contain information identifying a merchant account (such as account number, branch number, credit card number, shadow account identification etc). Preregistration by the merchant with the aggregation server 10 enables the aggregation server 10 to store details of a merchant account in the account database, thereby streamlining the process from the perspective of the merchant, as the merchant does not need to manually include its account details in the initiating SMS or other message.

In a further alternative embodiment, the merchant is registered with the aggregation server 10, but the receiving account identification information identifying the receiving account is a code included in the initiating SMS or other message.

An example of an initiating SMS message sent from the merchant device (the plumber's mobile telephone) is:

A17 455701123456 42595 0410557425 Receipt number 345659

The first three digits (“A17”) are a merchant identification code, identifying the merchant. As described above, this may not be necessary where the telephone number of the merchant's mobile telephone is used as an identification code (that is, receiving account identification information). Where devices other than mobile telephones are used, or where messaging systems other than SMS (such as instant messaging systems) are used, it is convenient to have an explicit merchant identification code within the message.

The next string of digits (following the space) represent the first 12 digits of the purchaser's 16-digit credit card number (that is, partial sending account data representing partial sending account details). These partial sending account details are insufficient to uniquely identify the sending account (that is, the purchaser's credit card).

The following string of digits (again, following space) is the quantum data representing an amount of the funds to be transferred (that is, the amount of the transaction), in cents. The amount of the transaction in this case is $425.95.

The subsequent string of digits (“0410557425”) is the second device identification data uniquely identifying a second device (in this case, the mobile telephone number of the purchaser).

The remaining text (“Receipt number 345659”) is description data representing a description associated with the transfer of funds. The merchant may use descriptor codes instead of a text description for standard goods or services. The aggregation server 10 can use these descriptor codes to look up a full description of the goods and/or services.

The aggregation server 10 executes computer-readable instructions to execute a first message receiving process 210 which listens for an initiating SMS message, received through a message receiving component such as an SMS Centre (SMSC) 215 (illustrated in FIG. 2). The received SMS message is sent to a message processing process 220 in the aggregation server 10. The message processing process 220 processes the received first data (the initiating SMS message) to derive a portion of the request data to be sent to the second device identified by the second device identification data (for example, the householder's mobile telephone). Where the merchant has not used SMS but some other mechanism to communicate with the aggregation server 10, such as a dedicated software application executing on a mobile computing device, or a web-based form, the message processing process 220 receives the message from an appropriate software interface of the aggregation server 10 (e.g. a World Wide Web server, in the case of the use of a web form).

Referring to the example initiating message given above, the message processing process 220 looks up a merchant account database to retrieve information about the receiving (merchant) account (step 105). Amongst other things, it retrieves the name of the merchant, and the merchant's account number (including branch details where necessary). It then constructs a request SMS containing request data. The request SMS may take the form:

<Merchant name> wants <amount> for <description>. Please reply with <transaction ID> last_four_digits_of credit_card expiry_date CVV name_on_card to confirm payment eg <transaction ID> 0123 0712 230 Peter Pan

As can be seen from this example, the <merchant name>, <amount> and <description> fields are derived from the initiating message from the merchant. The <transaction ID> is a unique alphanumeric transaction code generated by the aggregation server 10. An example request SMS message is.

Plumber Paul wants $425.95 for Receipt number 345659. Please reply with X417 last_four_digit of credit_card expiry _date CVV name_on_card to confirm payment eg X417 0123 0712 230 Peter Pan

This message is sent to the purchaser's telephone 225 by a request message transmitting component such as a request message transmitting process 230 in aggregation server 10 through an SMSC 215 (step 115),

Where the purchaser's device is a landline (or PSTN) telephone, this message may be sent to the purchaser by a call being made to the landline telephone and the message being read out to the purchaser through an interactive voice response or other interactive audio system.

A second message receiving component such as second message receiving process 235 awaits receipt from the purchaser's telephone 225 of a second message containing second transaction data representing a second portion of the information required to transfer the funds, If this second message is not received before the expiration of a predetermined time out (step 120), a check is made to determine whether the number of retransmissions of the first message has exceeded a predetermined threshold (step 125). If the predetermined threshold has not been exceeded, the first message is retransmitted (step 110). There are circumstances in which SMS messages are not successfully transmitted, and resending the request message until a response is received, a predetermined number of times, reduces the possibility that a transaction will be aborted due to a telecommunications error. If the predetermined threshold has exceeded, the transaction is aborted (step 130).

The purchaser may send the second message by SMS, where the second device (the purchaser's device) is a mobile telephone. However, if the purchaser's device is a landline, the purchaser may use another mechanism, such as an interactive voice response system, to provide information to the second message receiving process 235.

If the second message receiving process 235 receives a second message containing second transaction data representing a second portion of the information required to transfer the funds (step 135), it passes this information to a message combining component such as message combining process 240 which combines the first transaction data received from the merchant telephone 205 with second transaction data received from the purchaser's telephone 225 (step 140).

In the context of the example described above, the second message (response SMS) received from the purchaser or customer may be:

X417 7890 0411 123 Mr Tom Gold

The first string (“X417”) is the transaction identifier. The second string (“7890”) is the second part, or remainder, of the credit card details (being the last four digits). The third string (“123”) is the Card Security Code (otherwise known as the card verification value, card verification data, card verification value code, card verification code or card code verification), being a 3 digit number appearing on the back of the credit card. The last string (“Mr Tom Gold”) is the name on the card. In transmitting this SMS, the customer confirms the details of the transaction and authorises the transaction to take place. The information contained in this second message from the purchaser telephone 225 does not contain enough information, in itself, to execute the transaction. This message also does not have the complete details of the purchaser's credit card. Accordingly, should this message be intercepted (or unauthorised access be gained to a stored copy of this message), further information would be required before credit card fraud could be committed.

In an alternative embodiment, the purchaser may register with, and maintain an account on, aggregation server 10. Registered purchaser's may generate a second message by sending to the aggregation server 10 a predetermined authorisation code, or an SMS or other message from their mobile telephone (which may operate as an authorisation code), and details of the transaction such as the transaction identifier. The aggregation server may use the authorisation code or mobile telephone number to query a user database and retrieve information about the user, including partial user credit card details.

As an alternative to sending an SMS or using an interactive voice response system with a landline telephone, the purchaser may use a dedicated software application, or a web-based application or form, to provide the necessary information to the second message receiving process 235.

As described above, the message combining process 240 combines the first transaction data received from the merchant telephone 205, and the second transaction data received from the purchaser telephone 225 to generate combined transaction data. Where the first transaction data includes receiving account identification information identifying the receiving account (instead of simply receiving account information), receiving account data, retrieved from the account database, representing information about the receiving account is also combined with the first transaction data and second transaction data. For example, if the initialing SMS from the merchant telephone 205 contained a merchant code (for example “A17”), this code would be used to retrieve from the account database the full details of the merchant, including the merchant's bank account details. The message combining process 240 would combine the merchant's bank account details (the receiving account data) with the first transaction data and the second transaction data to generate combined transaction data.

An example of information included in the combined transaction data is:

Transaction amount: $429.95

Payer credit card number: 4557011234567890

Payer name on card: Mr Tom Gold

Card expiry: 0411

Card CSC: 123

Payee account: 047-208 255348

Payee name: Plumber Paul

Description: Receipt number 345659

This combined transaction data is sent to a transaction processor 250 by means of a transaction data transmission process 245 running on aggregation server 10 (step 150). The transaction processor 250 may be a processor controlled by a financial institution such as a bank. The transaction processor is responsible for executing the transfer of funds. The combined transaction data is sent to the transaction processor 250 by means of a secure channel.

A status receiving process 255 running on aggregation server 10 receives from the transaction processor 250 transaction completion data indicating whether the funds were successfully transferred from the sending account to the receiving account (step 160). The transaction completion data may be in the form of a flag or other binary indicator indicating success/failure. This transaction completion data may be processed to generate success data for subsequent transmission to the purchaser telephone 225 and merchant telephone 205 through status transmission process 260, and SMSC 215 (step 170).

Where the transaction has been successful, the SMS message sent to the merchant telephone 205 may be in the form:

Success—you have received a payment of $425.95 from Mr Tom Gold for transaction X417

A similar SMS message may be sent to the purchaser telephone 225:

Success—you have paid Plumber Paul $425.95 for transaction X417

If the transaction failed, an SMS message may be sent to the merchant telephone 205 in the form:

FAIL—payment FAILED from Mr Tom Gold for transaction X417

And to the purchaser telephone 775:

FAIL—payment FAILED for Plumber Paul for transaction X417.

Many modifications will be apparent to those skilled, in the art without departing from the scope of the present invention embodiments of which have herein been described with reference to the accompanying drawings. For example, although the embodiment above has been described in the context of the merchant and purchaser using mobile telephones connected with a mobile telephone network, and messages being sent using the Short Messaging Service, the invention could equally easily be used by any devices capable of sending and receiving messages (including instant messages) to and from an aggregation server 10. Although the aggregation server 10 is illustrated as a single server containing multiple executing processes, the number of processes required, and the number of computing systems that make up aggregation server 10, is a matter of design choice. For example, aggregation server 10 may be comprised of multiple computing units connected by a high-speed computer network. One or more processes may be executing on the aggregation server 10 to communicate with one or more SMSCs the case of communication by SMS) or other messaging facilities.

In addition, although the transaction described above involves the use of credit card details of a credit card of a purchaser, the invention is equally applicable to any financial transaction. For example, the partial sending account data may represent part of a bank account number, and not part of a credit card number.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

1. A computer-implemented method for facilitating the transfer of funds from a sending account to a receiving account, the method including the steps of:
receiving first data from a first device, the first data including:
first transaction data representing a ⁻first portion of information required to transfer the finds; and
second device identification data uniquely identifying a second device;
transmitting request data to the second device identified by the second device identification data, at least a portion of the request data being derived from the first data;
receiving from the second device second transaction data representing a second portion of the information required to transfer the funds; and
generating combined transaction data from the first transaction data and second transaction data for subsequent transmission to a transaction processor.
